(19) United States
(12) Patent Application Publication
(10) Pub. No.: US 2011/0314045 A1
(43) Pub. Date: Dec. 22, 2011

(54) FAST SET INTERSECTION

(75) Inventors: Arnd Christian König, Kirkland, WA (US); Bolin Ding, Urbana, IL (US)

(73) Assignee: Microsoft Corporation, Redmond, WA (US)

(21) Appl. No.: 12/819,249

(22) Filed: Jun. 21, 2010

(51) Int. Cl. G06F 17/30

(52) U.S. Cl. 707/769; 707/812; 707/803; 707/E17.009; 707/E17.014; 707/E17.044

(57) ABSTRACT

Described is a fast set intersection technology by which sets of elements to be intersected are maintained as partitioned subsets (small groups) in data structures, along with representative values (e.g., one or more hash signatures) representing those subsets. A mathematical operation (e.g., bitwise-AND) on the representative values indicates whether an intersection of range-overlapping subsets will be empty, without having to perform the intersection operation. If so, the intersection operation on those subsets may be skipped, with intersection operations (possibly guided by inverted mappings or using a linear scan) performed only on overlapping subsets that may have one or more intersecting elements.

### BACKGROUND

Set intersection is a very frequent operation in information retrieval, databases operations and data mining. For example, in an Internet search for a document containing some term 1 and some term 2, the set of document identifiers containing term 1 is intersected with the set of document identifiers containing term 2 to find the resulting set of documents having both terms.

Any technology that speeds up the set intersection process in such technologies is highly desirable. For example, the latency with respect to the time taken to return Internet search results is a significant aspect of the user experience. Indeed, if query processing takes too long before the user receives a response, even on the order of hundreds of milliseconds longer than expected, users tend to become consciously or subconsciously annoyed, leading to fewer search queries being issued and higher rates of query abandonment.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a fast set intersection technology by which sets of elements to be intersected are maintained as partitioned subsets (small groups) in data structures, along with representative values (e.g., hash signatures) representing those subsets, in which the results of a mathematical operation (e.g., bitwise-AND) on the representative values indicates whether an intersection of range-overlapping subsets is empty. If so, the intersection operation on those subsets may be skipped, with intersection operations performed only on overlapping subsets that may have one or more intersecting elements.

In one aspect, an offline pre-processing stage is performed to partition the sets of ordered elements into the subsets, and to compute the representative value (one or more hash signatures) for each subset. In an online intersection stage, the subsets from each set to intersect are selected, and any subset of one set that overlaps with a subset of another subset is evaluated for possible intersection, e.g., by bitwise-AND-ing their respective hash signatures to determine whether the result is zero (any intersection will be empty) or non-zero (there may be one or more intersecting elements). Only when there is a possibility of non-empty results is the intersection performed.

In one aspect, a plurality of independent hash signatures (e.g., three, obtained from different hash functions) is maintained for each subset. If any one mathematical combination of a hash signature with a corresponding (i.e., same hash function) hash signature of another subset indicates that an intersection operation, if performed, will be empty, the intersection need not be performed.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing an example use of a fast set intersection mechanism for query processing.

FIG. 2 is a representation of two sets of ordered elements partitioned into subsets having hash signatures being processed via overlapping subsets to determine possible intersection.

FIG. 3 is a block diagram representing two sets of ordered elements partitioned into subsets having hash signatures.

FIG. 4 is a representation of a data structure for maintaining a hash signature and elements for a subset.

FIG. 5 is a representation of a data structure for maintaining a plurality of hash signatures and elements for a subset.

FIG. 6 shows an illustrative example of a computing environment into which various aspects of the present invention may be incorporated.

### DETAILED DESCRIPTION

Various aspects of the technology described herein are generally directed towards a fast and efficient set intersection mechanism based upon algorithms and data structures. In general, in an offline pre-processing stage, sets are ordered, partitioned into subsets (smaller groups), and the smaller groups from one set numerically aligned with one or more of the smaller groups from the other set or sets. Each smaller group is represented by a value, such as provided by computing one or more hash values corresponding to the groups' elements.

In an online set intersection stage, a mathematical operation (e.g., a bitwise-AND) is performed on the representative (e.g., hash) value to determine whether any two aligned groups possibly intersect. Only if there is a possible intersection is an intersection performed on the small groups.

While the examples herein are directed towards information retrieval such as web search examples, e.g., intersecting sets of document identifiers, it should be understood that any of the examples herein are non-limiting, and other technologies (e.g., database and data mining) may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and data processing in general.

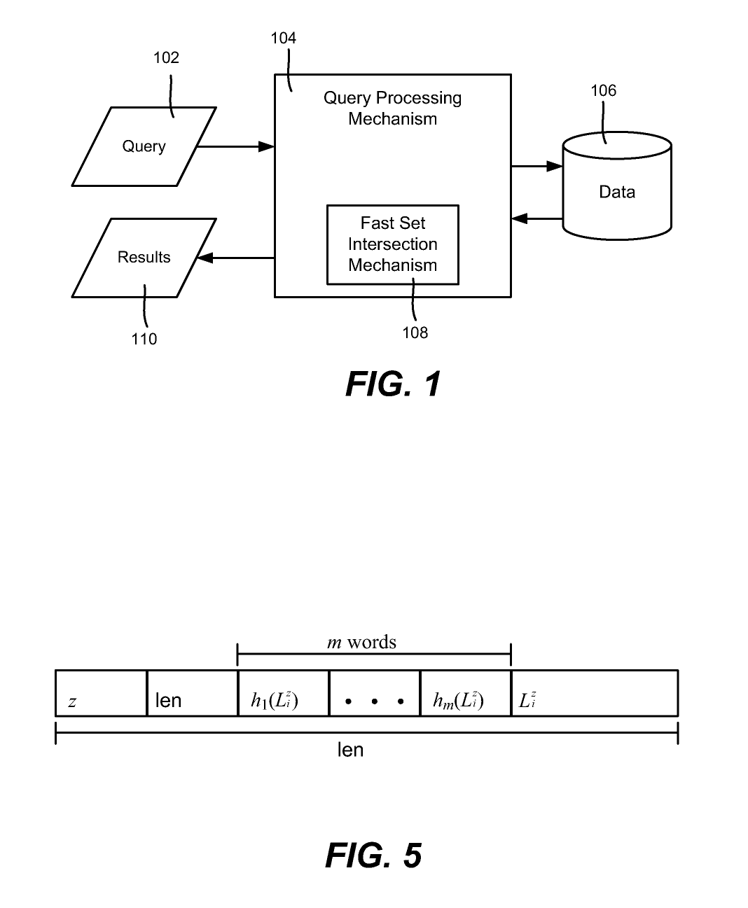

FIG. 1 shows a general application for the fast set intersection, in which a query 102 is received at a query processing mechanism 104 (e.g., an internet search engine or database management system). When the query 102 is one that requires a set intersection of two or more sets corresponding to data 106, the query processing mechanism 104 invokes a fast set intersection mechanism 108, which uses one or more the algorithms described below, or similar algorithms, to intersect the sets. The results 110 are returned in response to the query.

By way of example, the sets to be intersected may comprise lists of document identifiers, e.g., one set containing all of the document identifiers containing the term “Microsoft” and the other set containing all of the document identifiers containing the term “Office.” As can be readily appreciated, such lists may be extremely large at the web scale where billions of documents may be referenced.

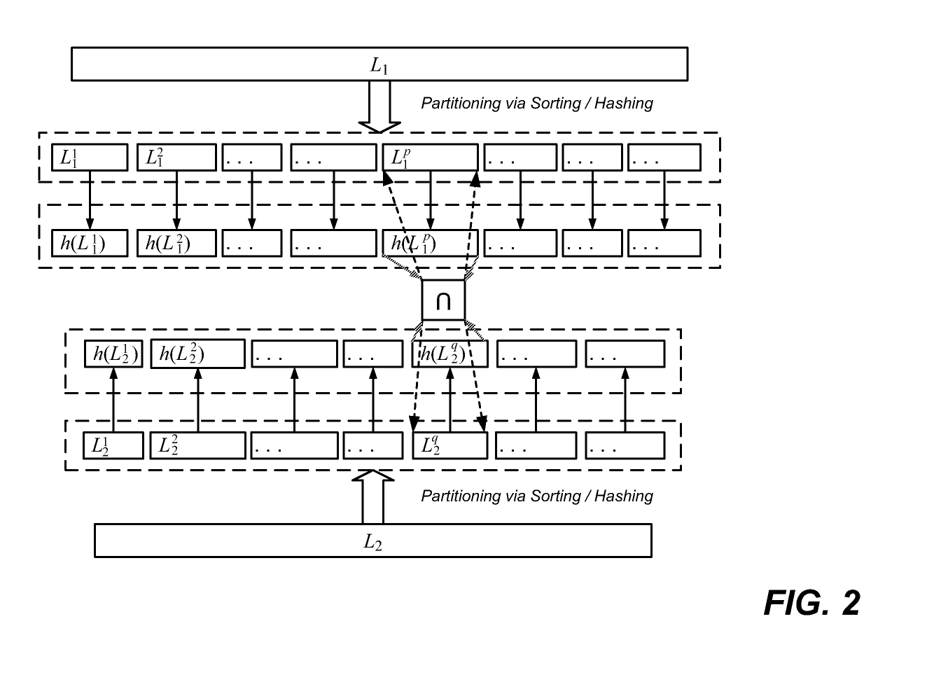

FIG. 2 shows two sets to be intersected, namely L₁ and L₂. Note that in web search, the intersection results are typically far smaller than either set. In general and as described below, the technique described herein partitions each set (which are sorted in order) into smaller subsets, with the subsets of each set numerically aligned with one another such that a subset of one set only overlaps (and can be intersected with) the numerically aligned subsets of the other set. In other words, each subset has a range of numbers, and alignment is by the ranges, e.g., a subset ranging from 10 minimum to 20 maximum such as {10, 14, 20} need not be intersected with a subset of the other set with a maximum value less than 10 e.g., {1, 2, 7} or a subset with a minimum value greater than 20 {e.g., 22, 28, 31}. Only aligned subsets need to be evaluated for possible intersection, as described below. Note that when hashing is used to partition, the subsets may not correspond to contiguous ranges; thus, what may be evaluated for possible intersection are subsets with possible value-overlap, (e.g. that are mapped to the same hash values).

Because the intersection results are typically so much smaller than the sizes of the original large sets, most of the small group intersections are empty. Described herein is efficiently and rapidly detecting those empty group intersections so that the online set intersection only needs to be performed on groups where an intersection may result in a non-empty result set. Note that the partitioning and other operations (e.g., hash computations) are performed in an offline pre-processing operation, and thus do not take any processing time during online set intersection processing.

Because of the offline pre-processing, the various sub-group elements and their representative (e.g., hash) values need to be maintained in storage for online access. As described below, a data structure encodes these data compactly, and allows the fast set intersection process/mechanism 108 to detect, in a constant number of operations (i.e., almost instantly) whether any two subsets have an empty intersection result. Only in the relatively infrequent event that the two subsets may not have an empty intersection result does the intersection operation need to be performed.

To this end, in addition to the values for each subset, a representative value such as a hash signature (or signatures) for the subset is maintained, as generally represented in FIG. 2, e.g., a 64-bit signature. As with the partitioning, the hash computations are performed in a pre-processing operation, and thus do not take any processing time during online set intersection processing.

When set intersection does need to take place in online processing, a logical bitwise-AND of the stored signatures for the aligned subsets efficiently detects whether there is any possibility of a subset intersection result that is not empty, e.g., the result of the AND operation is non-zero. As can be readily appreciated, such an AND operation and compare versus zero operation are among the fastest operations performed by computing devices. Note that it is possible that because of a hash collision that a false positive may occur, (whereby the intersection operation may be performed only to find out that the intersection result is empty), however whenever the AND operation results in zero, (which occurs frequently in information retrieval, for example), the intersection is certain to be empty.

As will be understood, described hereinafter are various ways to partition the sets into the subsets (small groups) to facilitate efficient data storage and online processing. In addition, described is determining which of the small groups to intersect, and how to compute the intersection of two small groups as described below.

Consider a collection of N sets S={L₁, . . . , L_{N}}, where Lᵢ is a subset of Σ and Σ is the universe of elements in the sets; let nᵢ=|Lᵢ| be the size of set Lᵢ. When referring to sets, inf(Lᵢ) and sup(Lᵢ) represent the minimum and maximum elements of a set Lᵢ, respectively. The elements in a set are ordered. The size (number of bits) of a word on the target processor is denoted by w. Pr[E] denotes the probability of an event E and E[X] denotes the expectation of a random variable X. Also, [w] denotes the set {1, . . . , w}.

A general task is to design data structures such that the intersection of arbitrarily many sets can be computed efficiently. As described above, there is a pre-processing stage that reorganizes each set and attaches additional index data structures, and an online processing stage that uses the pre-processed data structures to compute the intersections. An intersection query is specified via a collection of k sets L₁, L₂, . . . , Lₖ (to simplify the notation, the subscripts 1, 2, . . . , k are used to refer to the sets in a query). The general goal is to efficiently compute the intersections L₁∩L₂∩ . . . ∩Lₖ. Note that pre-processing is typical of the known techniques used for set intersections in practice. The pre-processing stage is time/space-efficient.

One concept described herein is that the intersection of two sets in a small universe can be computed very efficiently. More particularly, if sets are subsets of {1, 2, . . . , w}, they can be encoded as single machine-words and their intersection computed using a bitwise-AND. Another concept is that for the data distribution seen in text corpora, the size of an intersection is typically much smaller than the size of the smallest set being intersected (in this case, an O(|L₁|∩|L₂|) algorithm is better than an O(|L₁|+|L₂|) algorithm).

These concepts are leveraged by partitioning each set into smaller groups Lᵢ^{j}'s, which are intersected separately. In the preprocessing stage, each small group is mapped into a small universe [w]={1, 2, . . . , w} using a universal hash function h, and the image h(Lᵢ^{j}) encoded with a machine-word. Then, in the online processing stage, to compute the intersection of two small groups L₁^{p} and L₂^{q}, a bitwise-AND operation is used to compute H=h(L₁^{p})∩H(L₂^{q}).

The “small” intersection sizes seen in practice imply that a large fraction of pairs of the small groups with overlapping ranges have an empty intersection. Thus, by using the word-representations of H to detect these groups quickly, a significant amount of unnecessary computation is skipped, resulting in significant speedup.

The resulting algorithmic framework is illustrated in FIG. 2, e.g., partition into groups and hash the groups into representative values (offline), and perform the intersection only when an AND result of the hash values of aligned groups is non-zero. Given this overall approach, various aspects are directed towards forming groups, determining what structures are used to represent them, and how to process intersections of these small groups.

One way to intersect sets is via fixed-width partitions, e.g., eight elements per group. Consider a scenario when there are only two sets L₁ and L₂ in the intersection query. In a pre-processing stage, L₁ and L₂ are sorted, and partitioned into groups of equal size \sqrt{w} (except possibly the last groups; note that w is the word width as described above):

L₁¹,L₁², . . . ,L₁^{┌n}^{₁}^{/\sqrt{x}┐}, and L₂¹,L₂², . . . ,L₂^{┌n}^{₂}^{/\sqrt{x}┐}

In the online processing stage, the small groups are scanned in order, and the intersection L₁^{p}∩L₂^{q} of each pair of overlapping groups is computed; the union of all these intersections is L₁∩L₂ (Algorithm 1):

```
  1: p ← 1, q ← 1, Δ ←
  2: while p ≦ n₁ and q ≦ n₂ do
```

| | |
|---|---|
| 3: | if inf(L₂^{q}) > sup(L₁^{p}) then |

| | |
|---|---|
| 4: | p ← p + 1 |

| | |
|---|---|
| 5: | else if inf(L₁^{p}) > sup(L₂^{q}) then |

| | |
|---|---|
| 6: | q ← q + 1 |

| | |
|---|---|
| 7: | else |

| | |
|---|---|
| 8: | compute (L₁^{p} ∩ L₂^{q}) using IntersectSmall |
| 9: | Δ ← Δ ∪ (L₁^{p} ∩ L₂^{q}) |
| 10: | if sup(L₁^{p}) < sup(L₂^{q}) then p ← p + 1 else q ← q + 1 |

11: Δ is the result of L₁ ∩ L₂

If the ranges of L₁^{p} and L₂^{q} overlap, implying that it is possible that L₁^{p}∩L₂^{q}≠Ø, then L₁^{p}∩L₂^{q} is computed (line 8) in some iteration. Because each group is scanned once, lines 2-10 are repeated for O((nᵢ+n₂)/{square root over (w))} iterations.

Turning to computing L₁^{p} ∩L₂^{q} efficiently based upon pre-processing, each group L₁^{p} or L₂^{q} is mapped into a small universe for fast intersection. Single-word representations are leveraged to store and manipulate sets from a small universe.

With respect to single-word representation of sets, a set is represented as A ⊂ |w|={1,2, . . . , w} using a single machine-word of width w by setting the y-th bit as 1 if and only if yεA. This is referred to as the word representation w(A) of A. For two sets A and B, the bitwise-AND w(A)Λw(B) (computed in O(1) time) is the word representation of A∩B. Given a word representation w(A), the elements of A can be retrieved in linear time O(|A|). Hereinafter, if A ⊂ |w|, A denotes both a set and its word representation.

In the pre-processing stage, elements in a set Lᵢ are sorted as {xᵢ¹, xᵢ² . . . , xᵢⁿ^{ᵢ}} (i.e., xᵢ^{k}<xᵢ^{k+1}) and Lᵢ is partitioned as follows:

Lᵢ¹={xᵢ¹, . . . ,xᵢ^{\sqrt{w}}},Lᵢ²={xᵢ^{\sqrt{w}}, . . . , xᵢ^{2\sqrt{w}}} (1)

Lᵢ^{j}={xᵢ^{(j-1)\sqrt{w}+1},xᵢ^{(j-1)\sqrt{w}+2}, . . . , xᵢ^{j\sqrt{w}}} (2)

For each small group Lᵢ^{j}, the word-representation of its image is computed under a universal hash function h: Σ→[w], i.e., h(Lᵢ^{j})={h(x)|xεLᵢ^{j}}. In addition, for each position yε[w] and each small group Lᵢ^{j}, an inverted mapping is also maintained, h⁻¹(y,Lᵢ^{j})={x|xεLᵢ^{j} and h(x)=y}, i.e., for each yε[w], store the elements are stored in Lᵢ^{j} with hash value y, in a data structure supporting ordered access, e.g., a sorted list. The sort order for these elements is identical across h⁻¹(y,Lᵢ^{j}); this way, these short lists may be intersected using a simple linear merge.

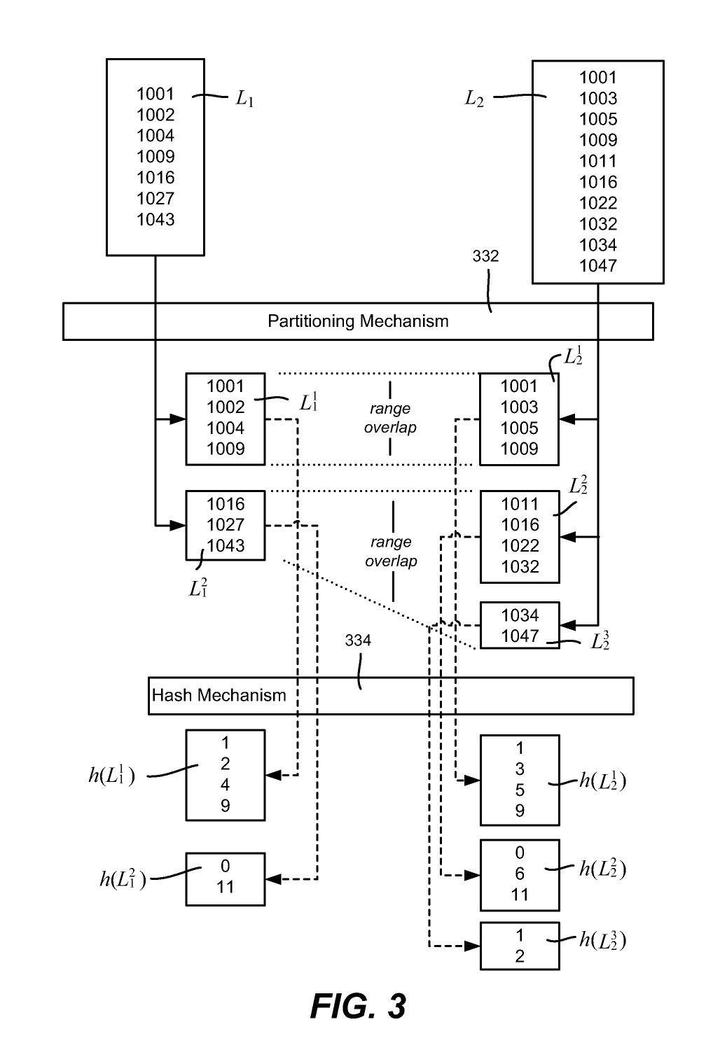

By way of example, FIG. 3 shows two sets, L₁={1001, 1002, 1004, 1009, 1016, 1027, 1043}, and L₂={1001, 1003, 1005, 1009, 1011, 1016, 1022, 1032, 1034, 10497}. In this example, the word length w=16(\sqrt{w}=4). For simplicity, h is selected to be h(x)=(x−1000 mod 16). The set L₁ is partitioned (by a partitioning mechanism 332 of the fast set intersection mechanism 108) into two groups, namely: L₁¹={1001, 1002, 1004, 1009} and L₁²={1016, 1027, 1043}, and L₂ is partitioned into three groups: L₂¹={1001, 1003, 1005, 1009}, L₂²={1011, 1016, 1022, 1032} and L₂³={1034, 1047}.

Via a hash mechanism 334 (of the fast set intersection mechanism 108), the process pre-computes h(L₁¹)={1, 2, 4, 9}, h(L₁²)={0, 11}, h(L₂¹)={1, 3, 5, 9}, h(L₂²)={0, 6, 11}, h(L₂³)={1, 2}. The inverted mappings (not shown) are also pre-processed, h⁻¹(y,Lᵢ^{p})'s: for example, h⁻¹(0, L₁²)={1016}, h⁻¹(11, L₁²)={1016, 1032}, h⁻¹(0,L₂²)={1027, 1043}, and h⁻¹(11,L₂²)={1011}.

Turning to the online processing stage, one algorithm used to intersect two lists is shown in Algorithm 1. Because the elements in L₁ are sorted, Algorithm 1 ensures that only if the ranges of any two small groups L₁^{p}, L₂^{q} overlap, their intersection needs to be computed (line 8). This is represented in FIG. 3 by the overlap of L₁² with L₂² and L₂³. After scanning all such pairs, Δ contains the intersection of the full sets.

To compute the intersection of two small groups L₁^{p}∩L₂^{q} efficiently, IntersectSmall (Algorithm 2) is provided, which first computes H=h(L₁^{p})∩h(L₂^{q}) using a bitwise-AND. Then for each (1-bit) yεh, Algorithm 2 intersects the corresponding inverted mappings using the simple linear merge algorithm:

IntersectSmall(L₁^{p}, L₂^{q}): computing L₁^{p} ∩ L₂^{q}

| 1: Compute H ← h(L₁^{p}) ∩ h(L₂^{q}) | |
|---|---|
| 2: for each y ∈ H do | |
| 3: | Γ → Γ ∪ (h⁻¹(y, L₁^{p}) ∩ h⁻¹ (y, L₂^{q})) |

4: Γ is the result of L₁^{p} ∩ L₂^{q}

By way of example of computing the intersection of small groups in online processing, to compute L₁∩L₂, the process needs to compute L₁¹∩L₂¹, L₁²∩L₂², and L₁²∩L₂³ (the pairs with overlapping ranges as represented in FIG. 3). For example, for computing L₁²∩L₂², the process first computes h(L₁²)∩h(L₂²)={0, 11}, then L₁²∩L₂²=∪_{y=0,11}(h⁻¹(y,L₁²)∩(h⁻¹(y,L₂²)={1016}. Similarly, the process computes L₁¹∩L₂¹={1001, 1009}. This results in h(L₁²)∩h(L₂³)=Ø, and thus L₁²∩L₂³=Ø. Thus, L₁∩L₂={1001, 1009}∪{1016}∪Ø.

Note that the word representations and inverted mappings are pre-computed, and the word-representations are intersected using one operation. Thus the running time of IntersectSmall is bounded by the number of pairs of elements, one from L₁^{p} and one from L₂^{q}, that are mapped to the same hash-value. This number can be shown to be approximately equal (in expectation) to the intersection size, with a bounding time of

$$O ( \frac{{n}_{1} + {n}_{2}}{\sqrt{w}} + r )$$

where

r=|L₁∩L₂|.

To achieve a better bound, the group sizes may be optimized into groups s*ᵢ=\sqrt{wn₁/n₂}, and s*₂=\sqrt{wn₂/n₁}, respectively, whereby L₁∩L₂ can be computed in expected O\sqrt{n₁n₂/w}+r time.

To achieve the better bound O\sqrt{n₁n₂/w}+r, multiple “resolutions” of the partitioning of a set Lᵢ are needed. This is because, as described above, the optimal group size s*₁=\sqrt{wn₁/n₂}, of the set L₁, also depends on the size n₂ of the set L₂ to be intersected with L₁. For this purpose, a set Lᵢ is partitioned into small groups of size 2, 4, . . . , 2^{j} and so forth.

To compute L₁∩L₂ for the given two sets, suppose s*ᵢ is the optimal group size of Lᵢ; the actual group size selected is s*ᵢ*=2^{t} such that s*ᵢ≦s*ᵢ*≦2s*ᵢ, obtaining the same bound. A properly-designed multi-resolution data structure consumes only O(nᵢ) space for Lᵢ, as described below.

There are limitations to fixed-width partitions, including that it is difficult to extend to more than two sets, because the partitioning scheme used is not well-aligned for more than two sets. For three sets, for example, there may be more than O((n₁+n₂+n₃)/\sqrt{w}) triples of small groups that intersect. A different partitioning scheme to address this issue is described below, which is extendable for k>2 sets, namely intersection via randomized partitions

In general, instead of fixed-size partitions, a hash function g is used to partition each set into small groups, using the most significant bits of g(x) to group an element xεΣ. This reduces the number of combinations of small groups to intersect, providing bounds similar to those described above for computing intersections of more than two sets.

In a pre-processing stage, let g be a universal hash function g: Σ→{0,1}^{w} mapping an element to a bit-string (or binary number). Note that gₜ(x) denotes the t most significant bits of g(x). For two bit-strings z₁ and z₂, z₁ is a t₁-prefix of z₂, if and only if z₁ is identical to the highest t₁ bits in z₂; e.g., 1010 is a 4-prefix of 101011.

When pre-processing a set Lᵢ, it is partitioned into groups Lᵢ^{z} such that Lᵢ^{z}={x|xεLᵢ} and gₜ(x)=z. As before, the word representation of the image of each Lᵢ^{z} is computed under another hash function h: Σ→{w}, and the inverted mappings for each group.

The online processing stage is similar to the algorithm described above, that is, to compute the intersection of two sets L₁ and L₂, the intersections of some pairs of overlapping small groups are computed, and the union of these intersections taken. In general, suppose L₁ is partitioned using gₜ_{₁}: Σ→{0,1}^{t}^{₁} and L₂ is partitioned using gₜ_{₂}: Σ→{0,1}^{t}^{₂}. Further, n₁≦n₂ and t₁≦t₂. Using this, sets L₁ and L₂ may be intersected using Algorithm 3 (two-list intersection via randomized partitioning):

| 1: for each z₂ ∈ {0, 1}^{t}^{₂} do | |
|---|---|
| 2: | Let z₁ ∈ {0, 1}^{t}^{₁} be the t₁-prefix of z₂ |
| 3: | Compute L₁^{z}^{₁} ∩ L₂^{z}^{₂} using IntersectSmall(L₁^{z}^{₁}, L₂^{z}^{₂}) |
| 4: | Let Δ ← Δ ∪ (L₁^{z}^{₁} ∩ L₂^{z}^{₂}) |

5: Δ is the result of L₁ ∩ L₂

One improvement of Algorithm 3 compared to Algorithm 1 is that Algorithm 1 needs to compute L₁^{p}∩L₂^{q} whenever the ranges of L₁^{p} and L₂^{q} overlap. In contrast, L₁^{z}^{₁}∩L₂^{z}^{₂} is computed when z₁ is a t₁-prefix of z₂ (this is a necessary condition for L₁^{z}^{₁}∩L₂^{z}^{₂}≠Ø, so Algorithm 3 is correct). This significantly reduces the number of pairs to be intersected.

Based on the choices of the parameters t₁ and t₂, L₁ and L₂ may be partitioned into the same number of small groups or into small groups of the (approximately) identical sizes.

To extend the process for more than two sets, that is, to compute the intersection of k sets L₁, . . . , Lₖ where nᵢ=|Lᵢ| and n₁≦ . . . ≦nₖ, Lᵢ is partitioned into groups L₁^{z}'s using gₜ_{ᵢ};

$${t}_{i} = ⌈ log ( \frac{{n}_{i}}{\sqrt{w}} ) ⌉ .$$

The process then proceeds as in Algorithm 4:

| 1: for each zₖ ∈ {0, 1}^{t}^{ₖ} do | |
|---|---|
| 2: | Let zᵢ be the tᵢ-prefix of zₖ for i = 1, . . . , k − 1 |
| 3: | Compute ∩ᵢ₌₁^{k} Lᵢ^{z}^{ₜ} using extended IntersectSmall |
| 4: | Let Δ ← Δ ∪ (∩ᵢ₌₁^{k} Lᵢ^{z}^{ₜ}) |

5: Δ is the result of ∩ᵢ₌₁^{k} Lᵢ

As can be seen, Algorithm 4 is almost identical to Algorithm 3, with a difference being that Algorithm 4 picks the group identifiers zᵢ to be the tᵢ-prefix of zₖ, such that the process only intersects groups that share a prefix of size at least tᵢ, and no combination of such groups is repeated. Also, the IntersectSmall algorithm (Algorithm 2) is extended to k groups; the process first computes the intersection (bitwise-AND) of hash images (their word-representations) of the k groups and, if the result is not zero, for each 1-bit, performs a simple linear merge over the k corresponding inverted mappings.

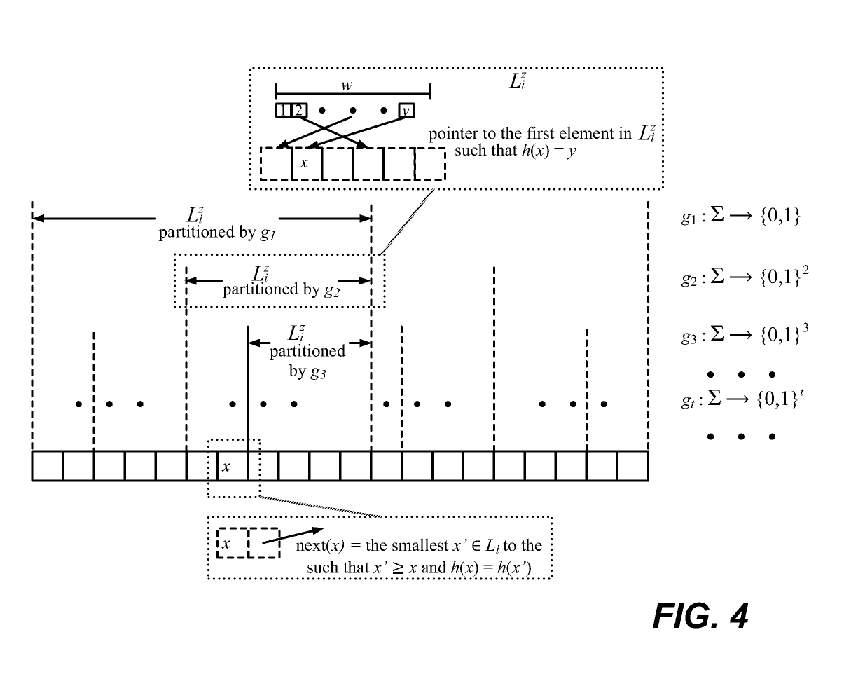

Turning to a multi-resolution data structure represented in FIG. 4, as described above, the selection of the number tᵢ of small groups used for a set Lᵢ depends on the other sets being intersected with Lᵢ. As a result, naively pre-computing the required structures for each possible tᵢ incurs excessive space requirements. Described herein and represented in FIG. 4 is a data structure that supports access to groupings of Lᵢ for any possible tᵢ, which only uses O(nᵢ) space. To enable the algorithms introduced so far, this structure allows retrieving the word-representation h(Lᵢ^{z}) and for each yε[w], to access all elements in the inverted mapping h⁻¹(y, Lᵢ^{z})={x|εLᵢ^{z} and h(x)=y} in linear time.

For simplicity, suppose Σ={0,1}^{w} and choose g to be a random permutation of Σ. Note that as used herein, universal hash functions and random permutations are interchangeable. To pre-process Lᵢ, the elements xεLᵢ are ordered according to g(x). Then any small group Lᵢ^{z} in the partition induced by gₜ (for any t) forms a consecutive interval in Lᵢ.

With respect to word representations of hash mappings, for each small group Lᵢ^{z}, the word representation h(Lᵢ^{z}) is pre-computed and stored. Note that the total number of small groups is

$$\frac{{n}_{i}}{2} + \frac{{n}_{i}}{4} + … + \frac{{n}_{i}}{{2}^{t}} + … \leq {n}_{i} ,$$

which uses O(nᵢ) space.

For inverted mappings, the elements in h⁻¹(y, Lᵢ^{z}) need to be accessed, in order, for each yε[w]. Explicitly storing these mappings consumes prohibitive space, and thus the inverted mappings are implicitly stored. To this end, for each group Lᵢ^{z}, because it corresponds to an interval in Lᵢ, the starting and ending positions are stored, denoted by left(Lᵢ^{z}) and right(Lᵢ^{z}). These allow determining whether a value x belongs to Lᵢ^{z}. To enable the ordered access to the inverted mappings, define, for each xεLᵢ, next(x) is defined to be the “next” element x′ to x on the right such that h(x′)=h(x), (i.e., with minimum g(x′)>g(x)). Then, for each Lᵢ^{z} and each yε[w], the data structure stores the position first(y, Lᵢ^{z}) of the first element x″ in Lᵢ^{z} such that x″=y.

To access the elements in h⁻¹(y, Lᵢ^{z}) in order, the process starts from the element at first(y,Lᵢ^{z}), and follows the pointers next(x), until passing the right boundary right(Lᵢ^{z}). In this way, the elements in the inverted mapping are retrieved in the order of g(x) which is needed by IntersectSmall. For all groups of different sizes, the total space for storing the h(Lᵢ^{z})'s, left(Lᵢ^{z})'s, right(Lᵢ^{z})'s, and next(x)'s is O(nᵢ).

While the above algorithms suffice, a more practical version is described herein, which in general is simpler, uses significantly less memory, has more straightforward data structures and is faster in practice. A difference is that for each small group Lᵢ^{z}, only stored are the elements in Lᵢ^{z} and their representative images, under multiple (m>1) hash functions. Note that inverted mappings are not maintained, as the process instead uses a simple scan over a short block of data. Also, the process uses only a single grouping for each set Lᵢ. Having multiple word representations of hash images for each small group allows detecting empty intersections of small groups with higher probability.

In a pre-processing stage, each set Lᵢ is partitioned into groups Lᵢ^{z}'s using a hash function gₜ_{ᵢ}. A good selection of tᵢ is

$$⌈ log ( \frac{{n}_{i}}{\sqrt{w}} ) ⌉ ,$$

which depends only on the size of Lᵢ. Thus for each set Lᵢ, pre-processing with a single partitioning suffices, saving significant memory. For each group, word representations of images are computed under m (independent/different) universal hash functions h₁, . . . , hₘ: Σ→[w]. Note that in practice, only a small value of m suffices, e.g., m=3.

In the online processing stage, the algorithm for computing ∩ᵢ Lᵢ (Algorithm 5) is generally the same as Algorithm 4, except that when needed, ∩ᵢLᵢ^{z}^{ᵢ} is directly computed by a simple linear merge of Lᵢ^{z}^{ᵢ} 's (line 4). Also, the process can skip the computation of ∩ᵢ Lᵢ^{z}^{ᵢ} if for some hⱼ, the bitwise-AND of the corresponding word representations hⱼ(Lᵢ^{z}^{ᵢ}) is zero (line 3). Algorithm 5:

1: for each zₖ ∈ {0, 1}^{t}^{ₖ} do

| | |
|---|---|
| 2: | Let zᵢ be the tᵢ-prefix of zₖ for i = 1, . . . , k − 1 |
| 3: | if ∩ᵢ₌₁^{k} hⱼ (Lᵢ^{z}^{ᵢ}) ≠ for all j = 1, . . . , m then |

| 4: | Compute ∩ᵢ₌₁^{k} Lᵢ^{z}^{ᵢ} by a simple linear merge of L₁^{z}, . . . , |
|---|---|
| | Lₖ^{z} |
| 5: | Let Δ ← Δ ∪ (∩ᵢ₌₁^{k} Lᵢ^{z}^{ᵢ}) |

6: Δ is the result of ∩ᵢ₌₁^{k} Lᵢ

Algorithm 5 is generally efficient because the chances of a false positive intersection resulting from a hash collision is already small, but becomes even smaller (significantly) given the multiple hash functions, each of which have to have a hash collision for there to be a false positive. Thus, most empty intersections can be skipped using the test in line 3.

As represented in FIG. 5, a simpler and more space-efficient data structure may be used with Algorithm 5. As described above, partition Lᵢ only needs to be partitioned using one hash function gₜ_{ᵢ}. As a result, each Lᵢ may be represented as an array of small groups Lᵢ^{z}, ordered by z. For each small group, the information associated with it may be stored in the structure shown in FIG. 5. The first word in this structure stores z=gₜ_{ᵢ}(Lᵢ^{z}). The second word stores the structure's length, len. The following m words represent the hash images. The elements of Lᵢ^{z} are stored as an array in the remaining part. Only needed is nᵢ/\sqrt{w} such blocks for Lᵢ in total.

Turning to another aspect, namely intersecting small and large sets, a simple algorithm may be used to handle asymmetric intersections, i.e., two sets L₁ and L₂ with significantly differing sizes, e.g., a 100 times size difference; (in this example L₂ is the larger set). The algorithm works by focusing on the partitioning induced by gₜ: Σ→{0,1}^{t}, where t=┌ log n₁┐ for both of them. To compute L₁∩L₂, the process computes L₁^{z}∩L₂^{z} for all zε{0,1}^{t} and takes the union of them. To compute L₁^{z}∩L₂^{z}, the process iterates over each xεL₁^{z}, and performs a binary search for L₁^{z} in L₂^{z}. In other words, the process selects an element from the smaller group, and uses a binary search to determine if there is an intersection with an element in the larger group.

### Exemplary Operating Environment

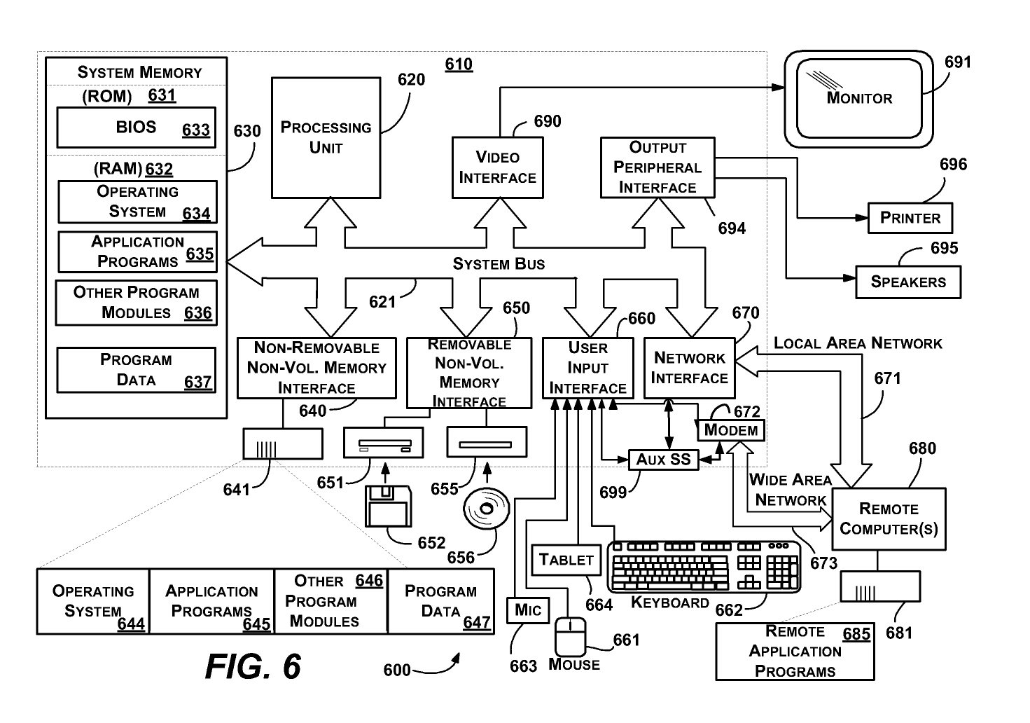

FIG. 6 illustrates an example of a suitable computing and networking environment 600 on which the examples of FIGS. 1-5 may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor comprising:
partitioning a first set of ordered elements into a first plurality of subsets;
computing a representative value for each subset of the first plurality of subsets;
partitioning a second set of ordered elements into a second plurality of subsets;
computing a representative value for each subset of the second plurality of subsets;
selecting one subset from the first plurality of subsets and another subset from the second plurality of subsets with possible value-overlap; and
using the representative value of the one subset and the representative value of the other subset to determine whether an intersection operation, if performed, is able to have non-empty results, and if so, performing an intersection operation on elements of the one subset and the other subset.

2. The method of claim 1 wherein computing the representative values comprises, for each subset, performing a hash computation to obtain a hash signature as at least part of the representative value for that subset.

3. The method of claim 2 wherein using the representative value of the one subset and the representative value of the other subset comprises performing a mathematical operation of the hash signature of the one subset and the hash signature of the other subset, in which a particular result determines that the intersection, if performed, is able to have non-empty results.

4. The method of claim 2 wherein using the representative value of the one subset and the representative value of the other subset comprises performing a bitwise-AND of the hash signature of the one subset and the hash signature of the other subset, in which a non-zero result determines that the intersection, if performed, is able to have non-empty results.

5. The method of claim 1 wherein partitioning the first set of ordered elements and partitioning the second set of ordered elements comprises determining partitions based upon a fixed-width partitioning scheme.

6. The method of claim 1 wherein partitioning the first set of ordered elements and partitioning the second set of ordered elements comprises determining partitions based upon a randomized partitioning scheme.

7. The method of claim 6 wherein partitioning the first set of ordered elements and partitioning the second set of ordered elements comprises using a hash computation on the elements to determine a respective subset.

8. The method of claim 1 wherein computing the representative values comprises, for each subset, performing a hash computation to obtain a hash signature as at least part of the representative value for that subset.

9. The method of claim 1 wherein computing the representative values comprises, for each subset of the first set, performing a plurality of hash computations using a plurality of independent hash functions to obtain a plurality of hash signatures that each comprise part of the representative value for that subset of the first set, and for each subset of the second set, performing a plurality of hash computations using a common plurality of the independent hash functions to obtain a plurality of corresponding hash signatures that each comprise part of the representative value for that subset of the second set.

10. The method of claim 9 wherein using the representative value of the one subset and the representative value of the other subset comprises, performing a mathematical operation on the hash signature of the one subset and the corresponding hash signature of the other subset to determine whether an intersection operation, if performed, has empty results, and if not, repeating the mathematical operation for a next corresponding pair of hash signatures until either the mathematical operation indicates that the intersection operation, if performed, has empty results, or no more corresponding pairs remain on which to perform the mathematical operation.

11. The method of claim 1 wherein performing the intersection operation comprises performing a linear search.

12. The method of claim 1 wherein performing the intersection operation comprises performing a binary search.

13. The method of claim 1 wherein partitioning the first set and the second set, and computing representative values for the subsets is performed in an online pre-processing stage, and wherein the selecting the subsets and using the representative values of the subsets is performed in an online processing stage.

14. In a computing environment, a system comprising, a fast set intersection mechanism, the fast set intersection mechanism including an offline component that partitions sets of ordered elements into subsets, computes at one or more associated hash signatures for each subset, and maintains each subsets and that subset's one or more associated hash signatures in a data structure, the fast set intersection mechanism including an online component that intersects two or more sets of elements, including by accessing the data structures corresponding to each set, determining from the one or more associated hash signatures whether the subset of one set, if intersected with a subset of another set, has an empty intersection result, and if not, performs an intersection operation on the subsets.

15. The system of claim 14 wherein the fast set intersection mechanism is incorporated into a query processing mechanism.

16. The system of claim 14 wherein the sets of ordered elements comprise sets of document identifiers.

17. The system of claim 14 wherein the data structure comprises a plurality of hash signatures, each hash signature computed via an independent hash function, and the ordered elements of that subset.

18. One or more computer-readable media having computer-executable instructions, which when executed perform steps, comprising, intersecting a plurality of sets of elements, including accessing data structures containing subsets of the elements, each data structure containing one or more associated hash signatures that each represent the elements of that subset, and for each subset of a set of elements that has a possible overlap with a subset of another set of elements, performing at least one bitwise-AND operation on corresponding hash signatures of the subsets to determine whether the intersection of those subsets is empty, and if not, performing an intersection operation on those subsets to obtain the elements or elements that intersect.

19. The one or more computer-readable media of claim 18 having further-executable instructions comprising, partitioning the sets into the subsets, computing the hash signatures of each subset, and maintaining the data structure for each subset.

20. The one or more computer-readable media of claim 19 wherein partitioning the sets into the subsets comprises using a hash computation.
